(19) United States
(12) Patent Application Publication
(10) Pub. No.: US 2023/0146791 A1
(43) Pub. Date: May 11, 2023

(54) A METHOD OF AT LEAST PARTIALLY BREAKING DOWN A MATERIAL OR PRODUCT ITEM OR A COMBINATION OF MATERIALS OR PRODUCT ITEMS

(71) Applicant: RDC TECHNOLOGIES LTD, Accrington Lancashire (GB)

(72) Inventors: John Norris, Blackburn Lancashire (GB); John Gerard Heffernan, Nelson Lancashire (GB)

(21) Appl. No.: 17/793,317

(22) PCT Filed: Jan. 15, 2021
(86) PCT No.: PCT/GB2021/050093

§ 371 Date: Jul. 15, 2022

(30) Foreign Application Priority Data
Jan. 16, 2020 (GB) 2000683.9
Jan. 17, 2020 (GB) 2000743.1

(51) Int. Cl. B01J 3/04; B09B 5/00; B09B 3/45

(52) U.S. Cl. CPC B01J 3/046; B09B 5/00; B09B 3/45; B01J 2219/00162

(57) ABSTRACT

A method of at least partially breaking down a material or product item or combination of material or product items. The method includes the steps of introducing said material or product item or combination of material or product items into a treatment vessel, introducing at least one working fluid into the treatment vessel, repeatedly increasing pressure on the material or product item or combination of material or product items in said treatment vessel to above atmospheric pressure and then subsequently depressurising the material or product item or combination of material or product items in the treatment vessel to achieve a pressure reduction in the vessel to effect at least partial breakdown of said material or product item or combination of material or product items.

### TECHNICAL FIELD OF THE INVENTION

The present invention relates generally to processing of a material or combinations of materials and particularly to an apparatus to effect at least partial breakdown of a material or combinations of materials.

### BACKGROUND TO THE INVENTION

In waste treatment sector, there are prior art methods for processing waste product items.

U.S. Pat. No. 4,540,467 to Grube discloses a method and apparatus for the removal of mould core material from metal castings and for fragmentation of municipal waste material, e.g., paper products, which involves heating and hydrating the materials within a pressure vessel. Chemicals active on the material to be processed or hydration water are added during hydration to soften the material to be removed or fragmented. Excess liquid in the vessel is drained and pressurized steam is added for a selected period of time. A suitable temperature and pressure are achieved such that the moisture or liquid carried by the processed material will rapidly turn to steam or vapor when the pressure in the vessel is rapidly reduced by quickly opening an unloading means at the bottom of the pressure vessel. The sudden release of the pressure in the vessel causes the moisture to change to steam and a certain portion of the liquid in the material to flash to vapor in accordance with thermodynamic laws. The resulting rapid expansion within the processed material fragments it.

Some of the issues with this prior art method include, the preferred procedure requires a treatment of the waste material with an appropriate chemical reagent. Thus, this step involves an additional “wet treatment” of the waste and there is the attendant cost of the chemicals involved. Secondly, the single cycle of pressurisation and explosive decompression may produce less than optimum fragmentation. Thirdly, under the conditions proposed in the document, plastics articles remain intact and are not fragmented.

International Patent Publication No. WO2012107732 to Norris is directed to a method for fragmenting a waste product comprising the steps of introducing said discrete waste product item into a pressure vessel, subjecting said item or items to an atmosphere of superheated steam in the vessel of at least 0.5 bar above atmospheric pressure, subsequently decompressing the vessel to achieve a pressure reduction of at least 0.5 bar in at most 5 seconds, and repeating steps (b) and (c) to effect fragmentation of said waste product item or combination of waste product items.

The method in Norris is based generally on treating a waste product item with at least two cycles of increased pressure superheated steam and then decompression to reduce the pressure by at least 0.5 bar in at most 5 seconds, to effect fragmentation.

The theory posited in this document is that the discrete waste product items are fragmented by the steam and flash decompression due to one or more of melting, hydrolysis and thermal decompression.

It is an object of the present invention to at least partially overcome or ameliorate any one or more of the disadvantages of the prior art methods described above.

### SUMMARY OF THE INVENTION

According to the present invention, there is provided a method of at least partially breaking down a material or product item or a combination of materials or product items, the method comprising the steps of:
a) introducing said material or product item or a combination of materials or product items into a treatment vessel or temporarily creating a treatment vessel from the material's or product item's or a combination of materials' or product items' existing casing(s) or carrier(s);
b) introducing at least one working fluid into the treatment vessel;
c) increasing pressure on the material or product item or combination of material or product items in said treatment vessel to above atmospheric pressure;
d) subsequently depressurising the material or product item or combination of material or product items in treatment vessel to achieve a pressure reduction on the material or product item or combination of material or product items in the treatment vessel in the vessel, and
e) repeating steps (c) and (d) at least once to effect at least partial breakdown of said material or product item or a combination of materials or product items.

Advantageously, the method of the present invention can provide the controlled breakdown of material or product item or a combination of materials or product items using pressure manipulation alone. The method can be used to effect at least partial breakdown of a material or product item or a combination of materials or product items, a combination of one or more materials or products or one or more materials or product items which are embedded in or located on a carrier product, preferably without any adverse effect on the carrier product.

Further, the method may function to remove or separate a material or product item or a combination of materials or product items from a carrier product.

The method of the present invention is directed towards the at least partial breakdown of material or product item or a combination of materials or product items.

The method may be implemented in a fixed or portable configuration. In other words, a treatment chamber which is fixed in location may be used or a treatment chamber which is portable may be used, depending upon the particular situation.

The method may be implemented in a treatment chamber which is large or small. The method may be used to treat material or product of a single type or kinds of material or product items or a combination of material or product of different types. The treatment of a single type of material or product may allow better targeting of the method, in particular the method parameters to achieve a more efficient or more complete breakdown of the material or product item or a combination of materials or product items.

The increase in pressure may be applied on the material or product item or combination of material or product items in the treatment vessel and/or within the treatment vessel.

Without wishing to be limited by theory, the method of the present invention preferably acts to mechanically break down the material or product item or a combination of materials or product items using pressure changes to disrupt the physical structure of the material or product item or a combination of materials or product items. In some circumstances, typically dependent upon the nature of the working fluid used, chemical breakdown may also occur.

The breakdown of the material or product item or a combination of materials or product items will preferably achieve at least some size reduction of the material or product item or a combination of materials or product items and/or decomposition of the material or product item or a combination of materials or product items.

The method parameters will typically be determined according to the material or product item or a combination of materials or product items to be treated and/or the mix if a combination of materials or product items is treated. The treatment regime of pressurisation and depressurisation will preferably begin only after the at least one working fluid has been introduced into the treatment vessel.

The material or product item or a combination of materials or product items are preferably loaded into a treatment vessel in which the method takes place. The item or items can be loaded into the vessel in any way.

The method may take place on a discrete, batch basis or a continuous basis. In certain circumstances, a hybrid basis can be used with a continuous series of batches being treated. Where the method is implemented on a continuous basis, it is preferred that the material or product item or a combination of materials or product items will have a particular residence time in the treatment chamber to effect at least partial breakdown.

In one continuous embodiment, a material to be treated (or a mixture containing one or more materials to be treated) can be introduced into a treatment vessel in the form of an elongate treatment vessel which may take the form of a duct, pipe, manifold or the like. The material to be treated (or a mixture containing one or more materials to be treated) is preferably conveyed through the treatment duct during treatment.

Pressurisation of the material to be treated (or a mixture containing one or more materials to be treated) may occur through the application of pressure using one or more injectors to create one or more zones of elevated pressure within the treatment duct in which pressurisation takes place and depressurisation occurs when the one or more injectors ceases to apply pressure and/or when the flow of material to be treated (or a mixture containing one or more materials to be treated) through the treatment duct moves the material to be treated (or a mixture containing one or more materials to be treated) out of the elevated pressure zone.

The pressure may be applied in one or more pulses through one or more injector. Multiple injectors may be provided radially or circumferentially about the treatment duct. Multiple injectors may be provided over the length of the treatment duct. High pressure working fluid may be introduced in pulse(s) via one or more injectors so as to rapidly pressurise a zone in the treatment duct. There may be multiple pulses from single phase injector(s) and/or multiple phases of injectors. Pressurisation may be achieved within the injector or prior to the injector feed. Depressurisation can be achieved as a result of absence of injector pulse.

The one or more injector may inject a combustible fluid such as hydrogen which, when mixed with another working fluid entering the inlet port and ignited results in a shock-wave and the creation of additional substances such as water vapour for example, which may form at least a part of the working fluid.

An injector may be provided substantially transverse to the direction of the flow through the treatment vessel, at an acute angle relative to the direction of the flow through the treatment vessel, in a counter current direction to the direction of the flow through the treatment vessel or at an angle relative to the counter current direction of the flow through the treatment vessel.

The number and configuration of injector(s) provide will depend on the treatment regime required. A ring of multiple injectors about the treatment duct can create a treatment zone through which the material must pass. Multiple rings over the length of the treatment vessel can form multiple treatment zones over the length of the treatment vessel.

One or more injectors can be provided in line within the treatment vessel. This can create a pulsejet configuration treatment vessel. In this configuration, treatment is intermittent, with the pressurisation and expulsion of each charge of working fluid or mixture preferably causing the intake of a fresh charge. The material or product to be treated may remain in position with the working fluid passing though the treatment vessel and/or any treated material exiting the vessel.

Provision of one or more injectors in a counter current direction to the direction of flow through the treatment vessel will typically increase the turbulence of the flow through the treatment vessel.

Any one or more injectors may take the form of a tap/valve/injector releasing pressure from an external generator/source/reservoir or may produce the pulse within the injector by mechanical/electro-mechanical/magnetic/piezoelectric/photoelectric/acoustic/ultrasonic/chemical/combustive means.

A low-pressure zone or vessel may be associated with an outlet of a treatment vessel. The low-pressure zone or vessel may be at or close to a vacuum.

The method of the present invention may form useful products from the at least partial breakdown of the material or product item or a combination of materials or product items. Downstream processing of any product streams from the method of the present invention may be undertaken to separate and/or recover any useful products formed.

Any stream exiting the apparatus of the present invention may be processed for recovery of the at least one working fluid, reprocessed using the same or alternative parameters or subject to further processing methods to separate, cleanse, purify or refine products of the process

The method of the present invention includes the step of introducing the material or product item or a combination of materials or product items into a treatment vessel. As mentioned above, the material or product item or a combination of materials or product items can be introduced into the treatment vessel in any way. For example, the material or product item or a combination of materials or product items may be conveyed into the treatment vessel either mechanically or using a fluid. The material or product item or a combination of materials or product items may be conveyed into the treatment vessel contemporaneously with the at least one working fluid. The material or product item or a combination of materials or product items may be conveyed into the treatment vessel by the at least one working fluid.

Once the material or product item or a combination of materials or product items have been introduced into the treatment vessel, the treatment vessel may be closed and sealed.

A mechanism may be provided, at least partially within the treatment vessel, to transport material or product to be treated into, through and/or out of the treatment vessel. For example, a screw conveyor, cable conveyor, chain conveyor, auger, or indexing mechanism may be provided. Preferably, any mechanism used will be able to be sealed in or to the treatment vessel.

In an embodiment, a conveyor may be provided to convey treated material out of a treatment vessel. A screw conveyor is preferred for this purpose. A screw conveyor can seal the exit from the treatment vessel through the formation of a plug of material in the screw conveyor. A screw conveyor may extend into the treatment vessel and may simply remove material. A screw conveyor may be provided through the treatment vessel which may allow the screw conveyor to convey material to be treated into the treatment vessel, support the material during treatment and then remove material from the treatment vessel. Preferably, if provided, a conveyor will be located in a lower portion of the treatment vessel but this would depend on the particular configuration.

In certain preferred embodiments, the treatment vessel may be sealed at all times, and the material or product item or a combination of materials or product items introduced and removed from the treatment vessel whilst the treatment vessel is still sealed. A continuous method of operation will typically require that the treatment vessel be sealed at all times. In one embodiment, the treatment vessel may be or include an elongate treatment vessel, such as a pipe, duct, manifold or similar for example, allowing both treatment and conveying of the material or product item or a combination of materials or product items contemporaneously. In other words, the material or product item or a combination of materials or product items may be treated as they are conveyed into, through and preferably out of the treatment vessel. The material or product item or a combination of materials or product items may be fixed in position within the treatment vessel during treatment.

The treatment vessel may therefore be sealed at any time relative to the other steps in the method. The treatment vessel may not be sealed, such as for example where the material or product item or a combination of materials or product items are treated as they are conveyed into, through and preferably out of the treatment vessel.

The method of the present invention can be adjusted to treat virtually any type of material or product item or a combination of materials or product items, including but not limited to physical waste such as bottles, general waste, household waste such as clothing and including difficult to treat waste such as nappies, sanitary napkins or sanitary towels and the like and even building waste such as carpet for example. The makeup of the material or product item or a combination of materials or product items will normally determine the makeup of the at least one working fluid and the specific parameters of the treatment regime.

The material or product item or a combination of materials or product items may be pre-treated before introduction into the treatment vessel. In one preferred embodiment, the material or product item or a combination of materials or product items may undergo size reduction prior to introduction. Size reduction will typically act to increase the surface area relative to volume of the material or product item or a combination of materials or product items prior to treatment.

Before entry to the treatment vessel, the material or product item or items may be subjected to one or more pre-treatment steps. It is particularly preferred that the material or product item or items undergo size reduction before treatment. Size reduction will typically lead to an increase in surface area per unit volume of the material or product item or items. Surface area of the material or product item or items will typically be an important factor in the efficacy of the treatment with a larger surface area generally leading to greater and/or faster breakdown. Any size reduction mechanism may be used but will typically be appropriate for the type of material or combination of types of material.

One of the pre-treatment steps may be or include maceration. The liquid used will preferably depend on the composition of the material or to be treated.

One of the pre-treatment steps may be or include a liquid content reduction step.

Pre-treatment may include subjecting the treatment volume to a number of preconditioning pressurisation steps to create optimum conditions.

A pre-treatment step may include dehydration of the material.

A pre-treatment step may include pre-soaking the material and/or product to be treated in at least one working fluid. The introduction of the material or product item or a combination of materials or product items into the treatment vessel may lead to placement of the material or product item or a combination of materials or product items in a particular location within the treatment vessel. The location of the material or product item or a combination of materials or product items may be an important parameter as to the effectiveness and/or completeness of the breakdown of the material or product item or a combination of materials or product items.

In one form, the method may include the step of introducing the material or product item or a combination of materials or product items into the treatment vessel in locating the material or product item or a combination of materials or product items within the treatment vessel such that the material or product item or a combination of materials or product items are accessible on one or more sides. In a preferred form, the material or product item or a combination of materials or product items will preferably be substantially centrally located, preferably spaced from the side walls of the treatment vessel. Though in certain applications of the method, to take advantage of working fluid flow characteristics or to enhance process performance, the location may be asymmetrical, against a wall or the material or product item or a combination of materials or product items may be free to move/oscillate.

A mount may be provided within the treatment vessel for location of the material or product item or a combination of materials or product items within the treatment vessel. Where provided, it is preferred that the mount is, or incorporates, a mesh mount to hold the material or product item or a combination of materials or product items. The provision of a mesh mount will typically hold the material or product item or a combination of materials or product items without unduly occluding any one or more parts of the material or product item or a combination of materials or product items.

In one preferred embodiment, the material or product item or a combination of materials or product items may be introduced into the treatment vessel using gravity.

In a preferred embodiment, the at least partial breakup of the material or product item or a combination of materials or product items may lead to a size reduction such that the smaller sized, at least partially broken up material or product item or a combination of materials or product items can fall through a mesh mount. The openings in the mesh may be sized to allow a particular size fraction of at least partially broken up material or product item or a combination of materials or product items to pass. This configuration of introduction of the material or product item or a combination of materials or product items into the treatment vessel and preferably removal of the material or product item or a combination of materials or product items using gravity may minimise the number of moving parts of the complexity of the introduction and removal process.

Based on the size reduction or the material or product item or a combination of materials or product items, it may be that the working fluid can then be used to fluidise the at least partially broken-down material or product item or a combination of materials or product items to then convey the at least partially broken-down material or product item or a combination of materials or product items through and/or out of the treatment vessel.

In a particularly preferred embodiment, the material or product item or a combination of materials or product items may be screened prior to introduction into the treatment vessel to remove larger items for further size reduction prior to treatment.

The treatment vessel may be fixed volume or variable volume. The volume of the treatment vessel will preferably be adjusted prior to introduction of the material or product item or a combination of materials or product items. Although the volume of the treatment vessel may be changed or adjusted during the treatment method to pressurise and depressurise the treatment vessel, it may be preferred that the treatment vessel has a fixed maximum working volume across any one treatment regime.

The working volume may be adjusted dynamically during the treatment regime to achieve desired process conditions or to maintain the pressure range within the vessel by compensating for any reduction in material volume during the process.

Reducing the working volume of the treatment vessel may allow higher pressures to be achieved within the treatment vessel. Still further, the size of the workpiece may be adjusted within a working volume (a larger workpiece in a given working volume may allow higher pressures to be achieved within the working volume).

As mentioned above, the method of the present invention may be used to treat material or product item or a combination of materials or product items introduced into the treatment vessel.

The method of the present invention may also be used to treat material or product item or a combination of materials or product items which is/are embedded in or located on the useful product or carrier, such as for example a filter element that carries waste product dirt or filtered material. The method of the present invention may be used to break down and/or remove waste product or filtered material from a filter element. If used in this way, it is preferred that the method of the present invention does not adversely affect the useful product, simply at least partially breaking down and preferably removing the material or product item or a combination of materials or product items from the useful product. In order to implement the method, an apparatus may be attached to the casing and/or the useful product or the whole useful product may be placed within a treatment vessel.

The method of the present invention includes the step of introducing at least one working fluid into the treatment vessel.

Preferably, the material or product item or items are located within the treatment vessel to allow the at least one working fluid access to multiple sides of the material or product. The material or product item or items will preferably be centrally located within the treatment vessel. The location of the material or product item or items may be dependent upon factors such as any standing wave and fluid velocity profile within the treatment vessel, the workpiece may need to be closer to one part of the treatment vessel than another for optimal treatment. The material or product to be treated may be provided in a location to maximise the pressure gradient to which the material or product is subjected or to facilitate desired fluid, particle and/or material movement.

The method may utilise any one or more working fluids.

In a preferred embodiment, the size of the charge of working fluid is adjusted to suit the size of the charge of the material or product item or a combination of materials or product items.

Preferably, the at least one working fluid will be gaseous rather than liquid. The at least one working fluid may include a mixture of phases. The at least one working fluid will preferably include a mixture of materials. If a mixture of materials is used, then the materials need not be of the same phase. For example, the gaseous carrier may be used with a hybrid phrase material such as steam.

The at least one working fluid may include at least one active component and at least one carrier.

Any type of at least one active component may be provided for example one or more reactants and/or one or more solvents may be provided with at least one carrier.

The method may further comprise the step of contacting the material or product item or items to be treated with at least one catalyst material. The at least one catalyst may be added to the treatment vessel and/or to the material or product item or items to be treated, before or during the treatment. The at least one catalyst will preferably be recovered and reused.

The at least one working fluid may be or incorporate atmospheric air with all of its components.

The at least one working fluid may be or incorporate steam, atmospheric air plus water vapour. Any percentage of water vapour may be used in the at least one working fluid. The working fluid may be or include refrigerant gasses such as HFCs and HFO.

The at least one working fluid may include one or more chemically volatile substances to complement and/or replace any one or more of the components such as for example any one or more of the components of atmospheric air.

The at least one working fluid may include one or more chemically volatile substances to complement and/or replace any one or more of the components.

The composition of the at least one working fluid will preferably be dependent upon the material or product item or combination of material or product items to be treated. For example, material or product items of materials based on organic components, such as plastic bottles for example, may be better treated by a working fluid which includes at least one organic component or organic solvent provided in an atmospheric air carrier.

If one or more components are used in the at least one working fluid, then one or more of the components may be recovered or removed from any exit stream(s).

The at least one working fluid will typically be introduced into the treatment vessel as a controlled feed. The particular composition of the at least one working fluid will preferably be dependent upon the material or product item or a combination of materials or product items to be treated. For example, materials based on organic components such as plastic bottles for example may be better treated by a working fluid which includes at least one organic component or organic solvent provided in atmospheric air carrier.

The at least one working fluid may be introduced into the treatment vessel from a reservoir or from a generator or both.

In one embodiment, the material or product item or items may be sufficiently reduced in size that the at least one working fluid can be agitated within the treatment vessel to the point where the at least one working fluid fluidises the material or product item or items within the treatment vessel during the treatment regime.

In one form, a portion of the at least one working fluid may be used in a bypass, cleansing or purge configuration to bypass all or part of the treatment vessel and/or process but be connected to an exit of the treatment vessel. The bypass configuration may be used to harness the Bernoulli effect or Venturi effect to assist with removal of the at least one working fluid and/or material or product item or combination of materials or product items from the treatment vessel. The volume of at least one working fluid in the feed compared to the volume in the bypass configuration is typically adjustable.

At least one recycle stream may be utilised in order to recycle a part of the at least one working fluid that has been used for treatment and which is recovered from an outlet.

The at least one working fluid may be injected into the treatment vessel. Injection of the at least one working fluid may agitate the atmosphere in the treatment vessel. Injection of the at least one working fluid prior to treatment may act to purge any existing atmosphere from the treatment vessel.

The at least one inlet is typically provided into the treatment vessel for the at least one working fluid. Typically, an inlet is provided for the at least one working fluid. Preferably an inlet is provided for introduction of the material or product item or a combination of materials or product items into the treatment vessel.

Typically, a charge of at least one working fluid may be introduced into the treatment vessel prior to initialisation of a treatment regime. The size of the charge of the at least one working fluid will typically depend upon the working volume of the treatment vessel and/or on the size of the charge of at least one material or item or items and/or the composition of the material or to be treated.

Additional working fluid(s) may be added to the treatment vessel over the course of the treatment regime. Any working fluid which is added during a treatment regime may be the same as or different to the working fluid added prior to the treatment regime beginning. A treatment regime may include different cycles using different working fluids or combinations of working fluids in order to effect the at least partial breakdown of the material or product item or items.

At least one exit is typically provided from the treatment vessel. Typically, an exit is provided for the at least one working fluid. Preferably, an exit is provided for the removal of the at least partially broken-down material or product item or combination of material or product items from the treatment vessel. The at least one working fluid and at least partially broken-down material or product item or combination of material or product items may exit through an exit together and be separated outside the treatment vessel.

The working fluid exit stream and/or at least partially broken-down material or product item or combination of material or product items exit stream may be treated to recover the at least one working fluid and/or any material that can be used to generate or complement the at least one working fluid.

The exiting at least one working fluid may be spent or wasted or recycled or undergo further processing for recovery, (re)forming, recycling, repurposing or the like.

A separation step to separate the at least one working fluid exiting the treatment vessel from the at least partially broken-down material or product item or items may be provided before the at least one working fluid is spent or wasted or recycled.

It may be that useful by-products are formed in the treatment vessel due to the at least partial breakdown of the material or product item or items and if so, any useful by-products may be separated from any exit stream leaving the treatment vessel.

The method of the present invention includes the step of increasing the pressure in the treatment vessel to above atmospheric pressure. The method of the present invention also includes the step of subsequently depressurising the treatment vessel to achieve a pressure reduction in the vessel. The steps are typically repeated to affect at least partial breakdown of the material or product item or combination of material or product items.

The increasing the pressure in the treatment vessel may be adiabatic pressurisation. This will typically cause the temperature (of a gas) of the working fluid to rise through adiabatic heating. The decreasing of the pressure in the treatment vessel may be adiabatic expansion. This will typically cause the temperature (of a gas) of the working fluid to drop through adiabatic cooling.

The increase in pressure may be achieved using any appropriate way. Some pressurisation methods and apparatus may have synergistic effects that go beyond pressure increase. Mechanisms such as heating may be used to increase pressure. Heating may have an additional synergistic effect of not only increasing the pressure but also heat treating of the material or product.

Heating may be used to augment the operation of the apparatus and/or as a primary mechanism to increase the pressure.

Heating may be provided in successive treatment vessels and/or zones. Heating may be provided repeatedly in a process vessel.

The decrease in pressure may be achieved using any appropriate way. Some depressurisation methods and apparatus may have synergistic effects that go beyond pressure decrease. Mechanisms such as cooling may be used to decrease pressure. Cooling may have an additional synergistic effect of not only decreasing the pressure but also treating of the material or product.

Cooling may be used to augment the operation of the apparatus and/or as a primary mechanism to decrease the pressure.

Cooling may be provided in successive treatment vessels and/or zones. Cooling may be provided repeatedly in a process vessel.

Each treatment regime will typically depend on the particular material or product item or combination of material or product items to be at least partially broken down. The treatment regime will typically be divided into a number of cycles of a pressurisation stage followed by a subsequent depressurisation stage.

Any arrangement or mechanism can be used to increase and/or decrease the pressure within the treatment vessel.

The treatment vessel may be a variable volume vessel. Preferably, the size of the working volume of the treatment vessel may be fixed during the treatment regime. Typically, the size of the working volume of the treatment vessel is adjusted prior to the treatment regime, normally to take account of the material or product item or combination of material or product items which are to be treated.

In one embodiment, the treatment vessel may be associated with at least one piston, telescopic arrangement or similar in order to adjust the size of the working volume of the treatment vessel.

The pressure changes in the treatment vessel will typically be implemented in any way for example mechanically or through the use of a physical phenomenon such as increasing pressure using heat.

In one form, the size of the working volume in the treatment vessel will preferably be reduced from the maximum size of the working volume, in order to increase pressure. In one form, the size of the working volume in the treatment vessel will preferably be increased in order to reduce the pressure in the treatment vessel.

In one embodiment, the treatment vessel may be associated with a pair of pistons associated with the treatment vessel. A first piston may preferably be provided to adjust the working volume of the treatment vessel prior to and/or during treatment.

A second piston may preferably be provided to change the size of the working volume in the treatment vessel to increase the pressure and decrease the pressure during the treatment regime.

The first piston will preferably be adjustable. A threaded adjustment mechanism or similar infinitely adjustable mechanism may be used. As mentioned, the working volume of the treatment vessel may be adjusted prior to treatment and may be maintained over the treatment regime.

The second piston is preferably movable, typically using a mechanism in order to control the pressurisation and depressurisation of the treatment vessel.

The or each treatment vessel may be sealed or at least partially sealed using a physical sealing device or member such as a valve for example. The or each treatment vessel may be sealed or at least partially sealed using a portion of the material to be treated to form a sealing ‘plug’. A portion of the material to be treated may be used in this way in relation to any one or more entry to the at least one treatment vessel and/or any one or more exit from the at least one treatment vessel.

A gas ‘plug’ may be used to seal or at least partially seal any one or more entry to the at least one treatment vessel and/or any one or more exit from the at least one treatment vessel. For example, back pressure could be used to prevent flow whilst pressure is applied.

The pressurisation and depressurisation stages will typically include operational parameters such as the duration of pressurisation, the duration of depressurisation (each of which respectively include both the overall time taken to pressurise and depressurise the treatment vessel as well as the speed or rate of pressurisation and depressurisation), the compression or pressurisation ratio, the depressurisation ratio and the like.

For example, the pressurisation stage may be longer in time than the depressurisation stage. The depressurisation stage will preferably be a flash or instantaneous depressurisation stage. The depressurisation step may simply be created by the removal or ceasing of the pressurisation.

The increase in pressure may take place over a period of time and then the pressure may be maintained at an elevated level for a period of time within the treatment vessel prior to depressurisation. Pressurisation may take place as a number of pressurisation steps. Each pressurisation step may include a decompression step. A decompression step following a pressurisation step may not be a flash or instantaneous depressurisation stage but merely a reduction is pressure followed by a further pressurisation step in order to build pressure prior to a flash or instantaneous depressurisation stage.

A control device will typically be provided to control the mechanism used to drive the at least one pressurisation and/or depressurisation mechanism.

The degree of pressurisation and decompression may be the same but implemented over a different time period.

One or more compression steps may be used. One or more decompression steps may be used.

The degree of pressurisation and depressurisation may differ. The degree of pressurisation and depressurisation may differ in different cycles across the treatment regime. For example, the degree of pressurisation in earlier cycles in a treatment regime may be less than the degree of pressurisation in later cycles, in order to build pressure in the treatment vessel and then the later cycles may reduce the pressure in the treatment vessel to a greater degree than the pressurisation in the immediately preceding pressurisation stage.

The increase in pressure within the treatment vessel may be a staged increase over a number of cycles, to a maximum treatment pressure, followed by a staged decrease in pressure over a number of cycles.

The duration of the pressurisation stage of each cycle is typically adjustable. The duration of the depressurisation stage of each cycle is typically adjustable.

The degree of pressurisation is typically adjustable. The degree of depressurisation is typically adjustable.

The number of pressurisation and subsequent depressurisation cycles in the treatment regime can be varied.

In a preferred form, the pressurisation stage of each cycle may be longer than the depressurisation stage. The degree of pressurisation may increase in later cycles in the same treatment regime.

In a preferred embodiment, the pressurisation and depressurisation of the treatment vessel can be achieved by the same apparatus or arrangement. Alternatively, the pressurisation and depressurisation of the treatment vessel can be achieved using different apparatus or arrangement, for example using a vent or similar valve for depressurisation. However, venting or other loss of the at least one working fluid is less preferred.

In one preferred form, multiple cycles of a pressurisation stage followed by a subsequent rapid depressurisation stage with a single charge of at least one working fluid will be used.

The treatment regime will normally include at least two cycles although many hundreds of thousands of cycles may be used for some treatments. The timing of the pressurisation stage can be any length from as short as less than 1 second to as long as 5 minutes or longer if need be. In addition, the pressurisation stage may be shorter than 1 second if necessary. The maximum pressure may be anywhere from atmospheric pressure to high pressure which is normally categorised as between 10,000 to 150,000 PSI.

The pressurisation/depressurisation may occur at any rate. For example, the rate of pressurisation/depressurisation may be relatively slow, for example between 0.0001-0.1 bar per second. This rate may be advantageous if the treatment effect is achieved through the pressurisation/depressurisation of the material to be treated. Alternatively, the rate of pressurisation/depressurisation may be more rapid, such as for example, any one or more of:

0.001-1 bar per second or

0.001-1 bar per millisecond or

0.001-1 bar per microsecond or

0.001-1 bar per nanosecond or

0.001-1 bar per picosecond.

The more rapid the depressurisation stage, the more explosive the depressurisation which may cause a different effect on the material to be treated.

The controlling parameters of each pressurisation stage and each subsequent rapid depressurisation stage will normally be determined prior to commencement of the treatment regime. As mentioned above, the parameters of each pressurisation stage and/or each subsequent rapid depressurisation stage, of each cycle, may be the same or different.

The particular design of the individual stages and the cycles will generally be important to the efficacy (degree of breakdown) and/or efficiency (time used) of the treatment regime.

Conservation of energy mechanisms may be utilised to reduce the overall energy consumption of the apparatus.

At least one agitator may be provided within the treatment vessel in order to circulate the at least one working fluid within the treatment vessel in order to create a homogeneous atmosphere within the treatment vessel as much as possible during the treatment regime.

The agitator may be a mechanical agitator. Agitation may be achieved by circulating the at least one working fluid carrying the material or product item or combination of materials or product items.

Agitation of the atmosphere within the treatment vessel could be achieved using the injection of additional material such as injection of additional working fluid or other material in a mixture of materials. An alternative method of agitation may be to rotate or move the treatment chamber.

Increasing the pressure and decreasing the pressure in the treatment vessel could be achieved by heating and cooling the treatment vessel or its contents but the subsequent rapid depressurisation, if affected by cooling, could have adverse consequences for the materials of construction.

Ignition of at least a part of the atmosphere within the treatment vessel could be used as a part of the treatment regime.

An ignition source may be provided within the treatment vessel and/or within an associated vessel.

In a preferred form, the pressurisation step may include increasing the pressure within the treatment vessel to a pressure above atmospheric pressure and holding the treatment vessel at an elevated pressure before the subsequent rapid depressurisation of the treatment vessel. In a preferred form, the depressurisation step may be followed by a period at a decreased pressure before the pressure is increased again in the treatment vessel.

The depressurisation of the treatment vessel may be to atmospheric pressure. The depressurisation of the treatment vessel may be to a pressure which is above atmospheric pressure but below the peak pressure achieved. The depressurisation of the treatment vessel may be to at or near vacuum.

As mentioned above, the depressurisation of the treatment vessel may be affected over a shorter time period than the pressurisation step. It is preferred that the depressurisation step be a flash or explosive depressurisation step.

The depressurisation step is preferably achieved by enlarging the working volume of the treatment vessel. The working volume may be enlarged to the starting volume, being less than the starting volume if total depressurisation is not desired.

As mentioned above, each treatment regime for the treatment of a charge of a material or product item or combination of material or product items will preferably include a number of cycles, with each cycle having a pressurisation and depressurisation stage with or without rest between the respective stages and/or one or more cycles.

The treatment regime will preferably include the introduction of a charge of material or product item or combination of material or product items and the introduction of the charge of at least one working fluid. The treatment regime will then typically follow a predetermined pattern and once the treatment regime is complete, the at least partially broken-down material or product item or combination of material or product items either/or the working fluid will typically be exhausted or removed from the treatment vessel.

The breakdown of the material or product item or combination of material or product items will typically be monitored during the treatment regime. If the treatment is effective before the number of cycles programmed for the treatment regime has been reached, then the treatment regime may be cut short.

The at least one working fluid may differ for different cycles within the same treatment regime. For example, at least some of the cycles of a treatment regime may take place with atmospheric air as the working fluid and at least some of the cycles of treatment regime may take place with steam as the working fluid and/or release of the cycles of treatment regime may take place with one or more solvents or reactants as or as a part of the at least one working fluid.

Where the working fluid is adjusted, it may be preferred that any reactive or solvent components of the at least one working fluid is used earlier in the treatment regime, particularly in circumstances where useful product is being treated for removal of dirt or material for example. In a preferred configuration, one or more later cycles may be or include steam and/or atmospheric air in order to flush or remove any material formed from the earlier use of reactive or solvent components of the at least one working fluid.

The controlling parameters of any one or more of the stages and/or cycles may be varied in real time depending upon the treatment effectiveness.

In one embodiment, an express or shorter treatment regime may be used.

In one embodiment, more robust pressurisation stage and depressurisation stage for any one or more cycles may be used to ‘shock treat’ the material or product item or combination of material or product items.

Monitoring equipment is typically associated with the treatment vessel or working volume of the treatment vessel in order to monitor the efficacy of the treatment. Monitoring equipment will typically be provided to monitor conditions to control at least the temperature and pressure within the working volume.

Preferably, monitoring equipment may be provided to monitor the degree of destruction/breakdown of the material or to be treated. Monitoring equipment may be provided to monitor the degree of cleanliness of a substrate or carrier of the material or mixture to be treated. If the treatment regime is effective in fewer cycles than programmed, then the treatment regime may be cut short or ended early to save time and/or energy.

Typically, monitoring, sample testing or the use of one or more indicator devices may be used in real-time or post process, allowing adjustments to the treatment regime to be made if necessary.

Any monitoring, sampling or indicator equipment may be used to monitor the conditions within the treatment vessel, the outside of the treatment vessel and/or one or more exits from the treatment vessel.

### DETAILED DESCRIPTION OF THE INVENTION

In order that the invention may be more clearly understood one or more embodiments thereof will now be described, by way of example only, with reference to the accompanying drawings, of which:

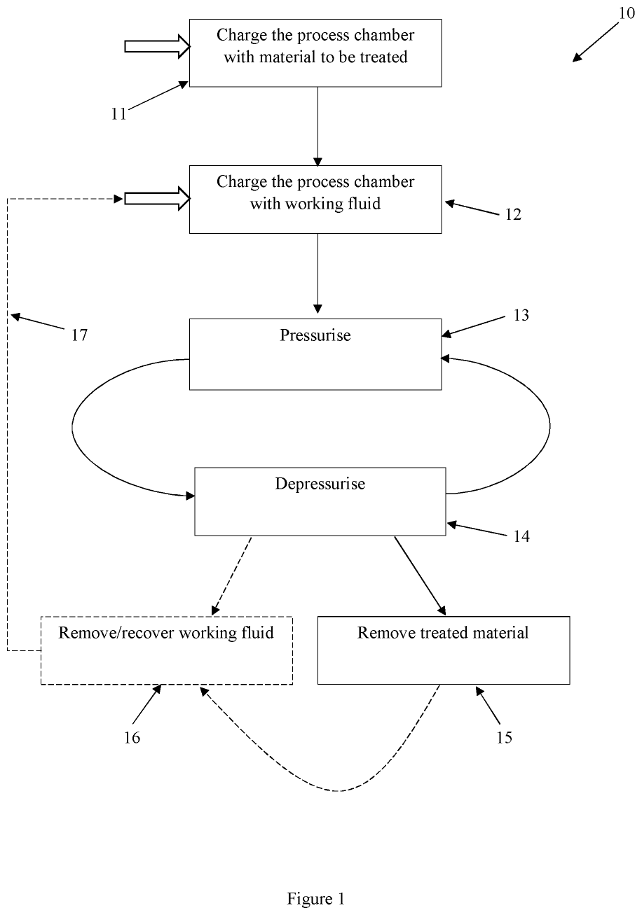

FIG. 1 is a schematic view of a method of at least partially breaking down a material or product item or combination of material or product items.

According to a particularly preferred embodiment of the present invention, a method of at least partially breaking down a material or product item or combination of material or product items is provided.

The particularly preferred embodiment of the method 10 illustrated comprises the steps of:
a) introducing a charge of material or product item or combination of material or product items into a treatment vessel at 11;
b) introducing one or more charges (or a continuous flow) of at least one working fluid into the treatment vessel at 12; and then

undertaking a treatment regime to at least partially breakdown the charge of material or product item or combination of material or product items, the treatment regime including a plurality of cycles of two stages, namely a first stage of increasing pressure in the treatment vessel to above atmospheric pressure at 13 and then subsequently depressurising the treatment vessel to achieve a pressure reduction in the vessel at 14.

Importantly, the treatment of the material or product item or combination of material or product items may be achieved by increasing pressure of the material or product item or combination of material or product items in the treatment vessel to above atmospheric pressure and then subsequently depressurising of the material or product item or combination of material or product items in the treatment vessel. In this context, the introduction of the charge of material or product item or combination of material or product items to be treated and the working fluid into the treatment vessel may occur at the same time.

The at least partially broken-down material or product item or combination of material or product items can then be removed from the treatment vessel at 15.

The method can be used to treat a material or product item, a combination of materials or product items of the same material, a combination of materials or product items of different materials or even materials or product items which are embedded in or located on a carrier product such as a filter element for example, with only limited, or without any, adverse effect on the carrier product. Further, the method can operate to remove or separate a material or product item or combination of material or product items from a carrier product.

The treatment of a single type of material or product item (or made of a single material) will normally allow better targeting of the operational parameters to achieve a more efficient or more complete breakdown of the material or product item or combination of material or product items.

In the preferred embodiment, the breakdown of the material or product item or combination of material or product items also achieves at least some size reduction of the material or product item or combination of material or product items and/or decomposition of the material or product item or combination of material or product items.

The material or product item or combination of material or product items are preferably loaded into a treatment vessel in which the method takes place. The material or product item or combination of material or product items can be loaded into the vessel in any way.

The method may take place on a discrete basis, batch basis or a continuous basis. Where the method is implemented on a continuous basis, it is preferred that the material or product item or combination of material or product items will have a particular residence time in the treatment chamber to effect at least partial breakdown. The treatment chamber for continuous treatment may be elongate such as a pipe, duct, manifold, channel or similar. Smaller-scale treatments may be undertaken on a batch basis, larger scale treatments may be continuous or hybrid processes.

As mentioned above, the material or product item or combination of material or product items can be introduced into the treatment vessel in any way. For example, the material or product item or combination of material or product items may be conveyed into the treatment vessel either mechanically or using a fluid. The material or product item or combination of material or product items may be conveyed into the treatment vessel contemporaneously with or even by the at least one working fluid. In one preferred embodiment, the material or product item or combination of material or product items may be fed into the treatment vessel using gravity.

In a batch process, once the material or product item or combination of material or product items have been introduced into the treatment vessel, the treatment vessel is then closed and sealed.

In certain preferred embodiments such as continuous treatment, the treatment vessel may be sealed at all times, and the material or product item or combination of material or product items introduced and removed from the treatment vessel whilst the treatment vessel is still sealed.

In one embodiment, the treatment vessel may be or include an elongate treatment vessel such as a pipe for example allowing both treatment of the material or product item or combination of material or product items and conveying of the material or product item or combination of material or product items through a treatment zone contemporaneously. In other words, the material or product item or combination of material or product items is treated as they are conveyed into, through and out of the treatment vessel.

The treatment vessel may therefore be sealed at any time relative to the other steps in the method, provided that it is sealed before the treatment regime begins. In another embodiment the treatment vessel or pipe/duct may not be sealed at any of or all stages in the process.

The material or product item or combination of material or product items may be pre-treated before introduction into the treatment vessel. In a particularly preferred embodiment, the material or product item or combination of material or product items may be screened prior to introduction into the treatment vessel to remove larger items for further size reduction prior to treatment. In one preferred embodiment, larger material or product item or combination of material or product items may undergo size reduction prior to introduction. Size reduction will typically act to increase the surface area relative to volume of the material or product item or combination of material or product items prior to treatment which will typically shorten the processing time.

The introduction of the material or product item or combination of material or product items into the treatment vessel will preferably ensure that the material or product item or combination of material or product items may be located or placed in a particular location within the treatment vessel substantially centrally, spaced from the side walls of the treatment vessel. In another embodiment they may be located in a non-central position to optimise the treatment process or allowed to move freely around the treatment vessel or zone.

A mount may be provided within the treatment vessel for location of the material or product item or combination of material or product items. The mount is preferably a mesh mount to hold the material or product item or combination of material or product items without unduly occluding any parts of the material or product item or combination of material or product items, as that will adversely affect the treatment of those parts.

In a preferred embodiment, breakup of the material or product item or combination of material or product items leads to size reduction of the treated material or product item or combination of material or product items such that the smaller sized, at least partially broken up material or product item or combination of material or product items can fall through a mesh mount. The openings in the mesh may be sized to allow a particular size fraction of at least partially broken up material or product item or combination of material or product items to pass. This configuration of introduction of the material or product item or combination of material or product items into the treatment vessel and preferably removal of the material or product item or combination of material or product items using gravity may minimise the number of moving parts of the complexity of the introduction and removal process.

Based on the size reduction or the material or product item or combination of material or product items, the working fluid may then be used to fluidise the at least partially broken-down material or product item or combination of material or product items, to then convey the at least partially broken-down material or product item or combination of material or product items through and/or out of the treatment vessel.

The treatment vessel of the preferred embodiment is a variable volume vessel. The volume of the treatment vessel can be adjusted prior to introduction of the material or product item or combination of material or product items according to the type and/or size of material or product item or combination of material or product items to be treated. The treatment vessel volume may be fixed volume across the treatment regime.

As mentioned above, method of the present invention may be used to treat material or product item or combination of material or product items introduced into the treatment vessel.

The method of the present invention may also be used to treat material or product item or combination of material or product items which is embedded in or located on the useful product such as for example a filter element that carries waste product dirt or filtered material by placing the filter element (as an example) into, or connecting to, the treatment vessel and/or pressurisation/depressurisation arrangement. The method of the present invention may be used to break material or product item or combination of material or product items down in situ on or in a product to be cleaned and remove the material or product item or combination of material or product items from an item such as a filter element. If used in this way, the method will not adversely affect the product to be cleaned, simply at least partially breaking down and preferably removing the material or product item or combination of material or product items from the product to be cleaned.

The method may utilise any one or more working fluids. The size of the charge of working fluid is adjusted to suit the size of the charge of the material or product item or combination of material or product items.

The working fluid is gaseous rather than liquid although the working fluid may include a mixture of phases such as steam for example.

The working fluid may include a mixture of materials. The working fluid may include at least one active component and at least one carrier for example one or more reactants and/or one or more solvents provided with at least one carrier.

One simple working fluid is atmospheric air with all of its components, including a percentage of water vapour.

The working fluid may be steam and any percentage of water vapour may be used.

The working fluid may include one or more chemically volatile substances to complement and/or replace any one or more of the components, such as for example any one or more of the components of atmospheric air.

The cycle of increasing the pressure and decreasing the pressure in the treatment vessel maybe an adiabatic cycle, where any temperature increase caused by pressurisation through adiabatic heating may be offset by the adiabatic expansion in the depressurisation stage of the cycle which may cause the temperature to drop through adiabatic cooling. Overall, it may be preferred that each cycle does not result in any appreciable temperature rise in the treatment vessel.

The particular composition of the working fluid for any treatment regime is dependent upon the material or product item or combination of material or product items to be treated. For example, materials based on organic components such as plastic bottles for example, may be better treated by a working fluid which includes at least one organic component or organic solvent provided in atmospheric air carrier typically with steam.

In one form, a portion of the working fluid is used in a bypass, purge or exit the treatment vessel without being subject to the full process cycle or undergoing full pressurisation and/or depressurisation through at least one bypass, purge or exit arrangement connected to an outlet of the treatment vessel, apparatus or process arrangement. The bypass, purge or exit configuration may utilise the Bernoulli effect or Venturi effect to assist with removal of the working fluid and/or material or product item or combination of material or product items from the treatment vessel. The volume of working fluid in the feed compared to the volume in the bypass, purge or exit is adjustable.

The working fluid may be injected into the treatment vessel which would agitate the atmosphere in the treatment vessel and may purge any existing atmosphere from the treatment vessel.

An inlet is provided into the treatment vessel for the working fluid and an inlet is provided for introduction of the material or product item or combination of material or product items into the treatment vessel. A single inlet for both the material or product item or combination of material or product items to be treated and the working fluid may be provided although the illustrated preferred method has the material or product item or combination of material or product items introduced first and the working fluid charge introduced thereafter.

An outlet is provided into the treatment vessel for the working fluid and an outlet is provided for introduction of the material or product item or combination of material or product items into the treatment vessel. Although a single outlet for both the material or product item or combination of material or product items to be treated and the working fluid may be provided, FIG. 1 shows that the working fluid can be removed separately at 16 and recycled 17 to the introduction step 12.

The working fluid exit stream and/or at least partially broken-down material or product item or combination of material or product items exit stream can be treated to recover the working fluid and/or any material that can be used to generate or complement the working fluid.

Each treatment regime will depend on the particular material or product item or combination of material or product items to be at least partially broken down. As mentioned above, each treatment regime is divided into a number of cycles of a pressurisation stage followed by a subsequent rapid depressurisation stage. Once the material or product item or combination of material or product items has been treated according to the treatment regime, then the treatment is completed and the material or product item or combination of material or product items (and working fluid) removed from the treatment vessel (although this can be monitored for effectiveness and shortened if necessary).

The pressure changes in the treatment vessel according to an embodiment are implemented mechanically, by varying the size of the working volume in the treatment vessel, with a reduction in the working volume in the treatment vessel in order to increase pressure and an increase in working volume in the treatment vessel in order to reduce the pressure in the treatment vessel.

In one embodiment, the treatment vessel is associated with a pair of pistons. A first piston is provided to adjust the working volume of the treatment vessel prior to treatment.

The first piston is adjustable to optimise the working volume of the treatment vessel prior to and during treatment and then may maintain the working volume over the treatment regime. The first piston has an associated threaded adjustment mechanism or similar arrangement to adjust the working volume and then manage the working volume.

The second piston is provided to change the size of the working volume in the treatment vessel to increase the pressure and decrease the pressure during the treatment regime. The second piston is movable preferably reciprocally movable, using a mechanism in order to control the pressurisation and depressurisation of the treatment vessel.

The increase in pressure may be achieved using any appropriate way. Some pressurisation methods and apparatus may have synergistic effects that go beyond pressure increase. Mechanisms such as heating may be used to increase pressure. Heating may have an additional synergistic effect of not only increasing the pressure but also heat treating of the material or product.

Heating may be used to augment the operation of the apparatus and/or as a primary mechanism to increase the pressure.

Heating may be provided in successive treatment vessels and/or zones. Heating may be provided repeatedly in a process vessel.

The decrease in pressure may be achieved using any appropriate way. Some depressurisation methods and apparatus may have synergistic effects that go beyond pressure decrease. Mechanisms such as cooling may be used to decrease pressure. Cooling may have an additional synergistic effect of not only decreasing the pressure but also treating of the material or product.

Cooling may be used to augment the operation of the apparatus and/or as a primary mechanism to decrease the pressure.

Cooling may be provided in successive treatment vessels and/or zones. Cooling may be provided repeatedly in a process vessel.

Pressurisation of the material to be treated (or a mixture containing one or more materials to be treated) may occur through the application of pressure using one or more injectors to create one or more zones of elevated pressure within the treatment duct in which pressurisation takes place and depressurisation occurs when the one or more injectors ceases to apply pressure and/or when the flow of material to be treated (or a mixture containing one or more materials to be treated) through the treatment duct moves the material to be treated (or a mixture containing one or more materials to be treated) out of the elevated pressure zone.

The pressure may be applied in one or more pulses through one or more injector. Multiple injectors may be provided radially or circumferentially about the treatment duct. Multiple injectors may be provided over the length of the treatment duct. High pressure working fluid may be introduced in pulse(s) via one or more injectors so as to rapidly pressurise a zone in the treatment duct. There may be multiple pulses from single phase injector(s) or multiple phases of injectors. Pressurisation may be achieved within the injector or prior to the injector feed. Depressurisation can be achieved as a result of absence of injector pulse.

The one or more injector may inject a combustible fluid such as hydrogen which, when mixed with another working fluid entering the inlet port and ignited, results in an increased-pressure shock-wave and the creation of additional substances such as water vapour for example, which may form at least a part of the working fluid.

An injector may be provided substantially transverse to the direction of the flow through the treatment vessel, at an acute angle relative to the direction of the flow through the treatment vessel, in a counter current direction to the direction of the flow through the treatment vessel or at an angle relative to the counter current direction of the flow through the treatment vessel.

The number and configuration of injector(s) provide will depend on the treatment regime required. A ring of multiple injectors about the treatment duct can create a treatment zone through which the material must pass. Multiple rings over the length of the treatment vessel can form multiple treatment zones over the length of the treatment vessel.

One or more injectors can be provided in line within the treatment vessel. This can create a pulsejet configuration treatment vessel. In this configuration, treatment is intermittent, with the pressurisation and expulsion of each charge of working fluid or mixture preferably causing the intake of a fresh charge. The material or product to be treated may remain in position with the working fluid passing though the treatment vessel and/or any treated material exiting the vessel.

Provision of one or more injectors in a counter current direction to the direction of flow through the treatment vessel will typically increase the turbulence of the flow through the treatment vessel.

Any one or more injectors may take the form of a tap/valve/injector releasing pressure from an external generator/source/reservoir or may produce the pulse within the injector by mechanical/electro-mechanical/magnetic/piezoelectric/photoelectric/acoustic/ultrasonic/chemical/combustive means.

A low-pressure zone or vessel may be associated with an outlet of a treatment vessel. The low-pressure zone or vessel may be at or close to a vacuum.

The duration of the pressurisation stage of each cycle is typically adjustable. The duration of the depressurisation stage of each cycle is typically adjustable.

The degree of pressurisation is typically adjustable. The degree of depressurisation is typically adjustable.

The number of pressurisation and subsequent depressurisation cycles in the treatment regime can be varied.

In a preferred form, the pressurisation stage of each cycle may be longer than the depressurisation stage. The degree of pressurisation may increase in later cycles in the same treatment regime.

In one preferred form, multiple cycles of a pressurisation stage followed by a subsequent depressurisation stage using a single charge of working fluid will be used.

In one form, the pressurisation step may include increasing the pressure within the treatment vessel to a pressure above atmospheric pressure and holding the treatment vessel at an elevated pressure before the subsequent depressurisation of the treatment vessel. In a preferred form, the depressurisation step may be followed by a period at a decreased pressure before the pressure is increased again in the treatment vessel.

The depressurisation of the treatment vessel may be to a pressure which is above atmospheric pressure but below the peak pressure achieved.

As mentioned above, the depressurisation of the treatment vessel is effected over a shorter time period than the pressurisation step. It is preferred that the depressurisation step be a flash or explosive depressurisation step.

The treatment regime will preferably include the introduction of a charge of material or product item or combination of material or product items and the introduction of the charge of at least one working fluid. The treatment regime will then typically follow a predetermined pattern and once the treatment regime is complete, the at least partially broken-down material or product item or combination of material or product items either/or the working fluid will typically be exhausted or removed from the treatment vessel.

The breakdown of the material or product item or combination of material or product items will typically be monitored during the treatment regime. If the treatment is effective before the number of cycles programmed for the treatment regime has been reached, then the treatment regime can be cut short.

The working fluid may differ for different cycles within the same treatment regime. For example, at least some of the cycles of a treatment regime may take place with atmospheric air as the working fluid and at least some of the cycles of treatment regime may take place with steam as the working fluid and/or release of the cycles of treatment regime may take place with one or more solvents or reactants as or as a part of the at least one working fluid.

In situations where the working fluid is changed during the treatment regime, any reactive or solvent components of the working fluid are normally used earlier in the treatment regime, particularly in circumstances where a useful product is being treated for removal of dirt or material for example. In a preferred configuration, one or more later cycles will include steam and/or atmospheric air in order to flush or remove any material formed from the earlier use of reactive or solvent components of the working fluid.

The one or more embodiments are described above by way of example only. Many variations are possible without departing from the scope of protection afforded by the appended claims.

1. A method of at least partially breaking down a material or product item or combination of material or product items, the method comprising the steps of:
a. introducing said material or product item or combination of material or product items into a treatment vessel or temporarily creating a treatment vessel from the material's or product item's or a combination of materials' or product items' existing casing(s) or carrier(s);
b. introducing at least one working fluid into the treatment vessel;
c. increasing pressure on the material or product item or combination of material or product items in said treatment vessel to above atmospheric pressure;
d. subsequently depressurising the material or product item or combination of material or product items in treatment vessel to achieve a pressure reduction on the material or product item or combination of material or product items in the treatment vessel in the vessel, and
e. repeating steps (c) and (d) at least once to effect at least partial breakdown of said material or product item or combination of material or product items.

2. A method as claimed in claim 1 wherein the steps of increasing pressure and subsequently depressurising comprises one treatment cycle and the method includes a plurality of treatment cycles.

3. A method as claimed in claim 1 or claim 2 implemented on a batch basis.

4. A method as claimed in claim 1 or claim 2 implemented on a continuous basis.

5. A method as claimed in claim 4 wherein the material or product item or combination of material or product items has a minimum residence time in the treatment vessel to effect at least partial breakdown.

6. A method as claimed in any one of the preceding claims further comprising one or more size reduction steps before introducing the material or product item or combination of material or product items into the treatment vessel.

7. A method as claimed in any one of the preceding claims wherein introducing the material or product item or combination of material or product items is achieved by conveying the material or product item or combination of material or product items into the treatment vessel either mechanically or using a fluid.

8. A method as claimed in any one of the preceding claims wherein the material or product item or combination of material or product items are introduced into the treatment vessel contemporaneously with the at least one working fluid.

9. A method as claimed in any one of the preceding claims wherein the treatment vessel is sealed during treatment, and the material or product item or combination of material or product items to be treated are introduced before sealing the treatment vessel and any products formed are removed from the treatment vessel after the treatment vessel is unsealed.

10. A method as claimed in any one of the preceding claims further comprising the step of locating the material or product item or combination of material or product items within the treatment vessel to be accessible on one or more sides during treatment.

11. A method as claimed in any one of the preceding claims further comprising the step of optimising the volume of the treatment vessel prior to during or after the introduction of the material or product item or combination of material or product items and controlling/managing a volume during treatment.

12. A method as claimed in any one of the preceding claims further comprising the step of optimising an amount of working fluid introduced to suit the material or product item or combination of material or product items introduced.

13. A method as claimed in any one of the preceding claims further comprising the step of allowing a portion of the at least one working fluid to bypass, purge or exit the treatment vessel without being subject to the full process cycle or undergoing full pressurisation and/or depressurisation through at least one bypass, purge or exit arrangement connected to an outlet of the treatment vessel, apparatus or process arrangement.

14. A method as claimed in any one of the preceding claims wherein the at least one working fluid is injected into the treatment vessel, using at least one injector.

15. A method as claimed in any one of the preceding claims further including the step of treating any exit stream from the treatment vessel to recover the at least one working fluid and/or any other useful material.

16. A method as claimed in any one of the preceding claims wherein the step of increasing the pressure in the treatment vessel is adiabatic pressurisation.

17. A method as claimed in any one of the preceding claims wherein the step of depressurising the treatment vessel is adiabatic expansion.

18. A method as claimed in any one of the preceding claims wherein the step of increasing the pressure in the treatment vessel is of adjustable duration.

19. A method as claimed in any one of the preceding claims wherein the step of depressurisation of the treatment vessel is of adjustable duration.

20. A method as claimed in any one of the preceding claims wherein the step of increasing the pressure in the treatment vessel is adjustable in degree of pressure increase.

21. A method as claimed in any one of the preceding claims wherein the step of depressurisation of the treatment vessel is adjustable in degree of pressure decrease.

22. A method as claimed in any one of the preceding claims wherein the step of increasing the pressure in the treatment vessel is longer in duration than the depressurisation step.

23. A method as claimed in any one of the preceding claims wherein the step of increasing the pressure in the treatment vessel and subsequent depressurisation step occurs a plurality of times with a single charge of at least one working fluid.

24. A method as claimed in any one of the preceding claims further including the step of agitating an environment within the treatment vessel in order to circulate the at least one working fluid within the treatment vessel.

25. A method as claimed in claim 24 wherein agitating the environment within the treatment vessel fluidises the material or product item or combination of material or product items with the at least one working fluid.

26. A method as claimed in any one of the preceding claims wherein the step of increasing the pressure in the treatment vessel is followed by a step of holding the treatment vessel at an elevated pressure before the subsequent depressurisation of the treatment vessel.

27. A method as claimed in any one of the preceding claims further including a step of monitoring the at least partial breakdown of the material or product item or combination of material or product items or treatment vessel for treatment effectiveness.

28. A method as claimed in claims 27 wherein the steps of increasing the pressure in the treatment vessel and subsequent depressurisation of the treatment vessel are varied in real time depending upon the treatment effectiveness.

29. A method as claimed in any one of the preceding claims wherein the at least one working fluid is gaseous.

30. A method as claimed in any one of the preceding claims wherein the at least one working fluid comprises a mixture of phases.

31. A method as claimed in any one of the preceding claims wherein the at least one working fluid comprises a mixture of materials.

32. A method as claimed in any one of the preceding claims wherein the at least one working fluid comprises at least one active component and at least one carrier.

33. A method as claimed in claim 32 wherein the at least one active component comprises one or more reactant and/or one or more solvent.

34. A method as claimed in claim 32 or claim 33 wherein the at least one active component comprises one or more volatile substances.

35. A method as claimed in any one of the preceding claims further including contacting the material or product item or combination of material or product items with at least one catalyst material.

36. A method as claimed in any one of the preceding claims wherein the increase in pressure is applied to the material or product item or combination of material or product items in the treatment vessel.

37. A method as claimed in any one of the preceding claims wherein the increase in pressure is applied within the treatment vessel.

38. A method as claimed in any one of the preceding claims wherein the increase in pressure is applied through the application of at least two pulses of increased pressure and the depressurising occurs through the absence of increased pressure applied by the at least two pulses of increased pressure.
